(19) United States
(12) Patent Application Publication
(10) Pub. No.: US 2017/0320245 A1
(43) Pub. Date: Nov. 9, 2017

(54) Process To Manufacture Ultra High Filled Urethane Foam

(71) Applicant: Magna Seating Inc, Aurora (CA)

(72) Inventor: Eric Kozlowski, Oakland Township, MI (US)

(21) Appl. No.: 15/586,651

(22) Filed: May 4, 2017

Related U.S. Application Data
(60) Provisional application No. 62/331,518, filed on May 4, 2016.

(51) Int. Cl. B29C 44/34; C08J 9/00; B29L 31/00; B29K 105/04; B29K 75/00; B29K 105/16

(52) U.S. Cl. CPC B29C 44/3407; C08J 9/0085; C08J 9/0066; B29K 2105/16; B29K 2105/04; B29K 2075/00; C08J 2375/04; B29L 2031/771

(57) ABSTRACT

A process for manufacturing a urethane foam pad comprising the steps of: providing a urethane resin and a filler agent; mixing a predetermined amount of the filler agent with the urethane resin to create a urethane mixture within a mold container; drawing a vacuum on the urethane mixture; allowing the urethane mixture to expand and gel for a predetermined amount of time to form an expanded urethane foam pad; releasing the vacuum on the urethane mixture; and removing the expanded urethane foam pad from the mold container.

### CROSS-REFERENCE TO RELATED APPLICATIONS

This application claims priority to U.S. Provisional Application No. 62/331,518, filed on May 4, 2016.

### BACKGROUND OF THE INVENTION

### 1. Field of the Invention

The present invention relates to a process to manufacture ultra high filled urethane foam. More particularly, the invention relates to manufacturing a urethane foam pad with improved thermal conductivity for increasing the heat transfer through the foam pad.

### 2. Description of Related Art

Automotive vehicles include one or more seat assemblies having a seat cushion and a seat back for supporting a passenger or occupant above a vehicle floor. The seat assembly is commonly mounted to the vehicle floor by a riser assembly. The seat back is typically operatively coupled to the seat cushion by a recliner assembly for providing selective pivotal adjustment of the seat back relative to the seat cushion. Each of the seat cushion and seat back commonly comprise a base foam pad supported by a rigid frame structure and encased in a textile trim cover of cloth, leather, and/or vinyl. The base foam pad provides the firm support and durability to the seat cushion and seat back. A trim foam pad, commonly referred to as a plus pad, is also frequently disposed between the base foam pad and the trim cover to provide a softer surface for seat occupant comfort and to improve the appearance of the seat.

It is commonly known to provide seat assemblies with heating and cooling mechanisms for selectively heating and cooling the surface of the seat for seat occupant comfort. These known heating and cooling mechanisms are typically independent mechanisms. For example, it is common to provide an electric wire heating pad between the foam pad and trim cover of the seat cushion or seat back which is electrically actuated by the power from the vehicle battery to electrically charge the heating pad and provide heat to the surface of the seat cushion or seat back. It is also known to provide fans and air ducts to force cool air through the foam pad and trim cover and provide cool air to the surface of the seat cushion or seat back. It is also known to provide fans and ducts to draw warm, moist air away from the seating surface to provide a gradual cooling effect.

However, current heating and cooling mechanisms require a fair amount of time and power to generate sufficient heat or cool air to affect the temperature of the seat assembly and the desired comfort for the seat occupant.

Additionally, the base foam pad and the trim plus pad are typically composed of cellular urethane foam having a very low thermal conductivity, and as such, heat can build up between the seat occupant and padding materials. The base foam pad and trim plus pad also act as an insulator rather than transferring the heat or cold to the surface of the seat assembly, and thus the power levels of the heating and cooling mechanisms have to be substantial to overcome the insulating properties and effects of the foam pads.

It is desirable, therefore, to provide a thermally conductive foam pad for transferring and dispersing the heat or cold to and from the surface of the seat assembly. It is also desirable to provide a process for manufacturing ultra high filled urethane foam with filler materials to improve the thermal conductivity of the foam.

### SUMMARY OF THE INVENTION

A process for manufacturing a urethane foam pad is provided comprising the steps of: providing a urethane resin and a filler agent; mixing a predetermined amount of the filler agent with the urethane resin to create a urethane mixture within a mold container; drawing a vacuum on the urethane mixture; allowing the urethane mixture to expand and gel for a predetermined amount of time to form an expanded urethane foam pad; releasing the vacuum on the urethane mixture; and removing the expanded urethane foam pad from the mold container.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a container of urethane resin and a container of filler agent;

FIG. 2 is a perspective view of a mold container of the filler agent added to the urethane resin;

FIG. 3 is a perspective view of the mold container of a urethane mixture of the resin and filler agent;

FIG. 4 is a perspective view of the mold container on a vibration table;

FIG. 5 is a perspective view of the mold container placed in a vacuum chamber;

FIG. 6 is perspective view of the urethane mixture in the mold container prior to vacuum draw and foam expansion;

FIG. 7 is a perspective view of the urethane mixture in the mold container after vacuum draw and foam expansion; and

FIG. 8 is a perspective view of a plurality of expanded foam plus pads formed by the urethane foam process.

### DETAILED DESCRIPTION OF THE EMBODIMENTS

In the automotive seating industry, as one example of use, a seat assembly generally includes a horizontal seat cushion and a generally upright seat back for supporting a seat occupant within the vehicle as is commonly known in the art. Each of the seat cushion and seat back commonly include a molded resilient cellular foam base pad encased in a trim cover, commonly of cloth, vinyl, or leather. The base pad provides the resilient support to the seat occupant. A trim pad, commonly referred to as a plus pad, is typically positioned between the base pad and the trim cover to provide softer surface comfort to the seat occupant and to improve the appearance of the seat. However, both the base pad and the trim plus pad currently have a very low thermal conductivity of approximately 0.043 W/m-K, and as such, heat can build up between the seat occupant and the trim plus pad. It is also commonly known to provide a heating or cooling mechanism, such as an electric heating pad, in the seat assembly for providing occupant comfort. However, the trim plus pad acts as an insulator, and therefore, the desired heating and cooling effects take considerable time to be felt by the occupant. Further, the power levels of the heating and cooling mechanisms have to be substantial to overcome the insulating effects of the trim plus pad.

The trim plus pad is typically manufactured of urethane foam which includes millions of air pockets that permeate the foam and make it naturally insulating. It is currently known to add filler materials to the urethane foam using a variety of filling agents to enhance the thermal properties of the foam. For example, foams have been created in the bedding industry with enhanced thermal properties by using filling agents including graphite, aluminum, aluminum oxide, silver, copper, as well as other conductive fibers. However, because of the chemistry of urethane foam, the amount of filler is limited. That is, at high loading or filling levels above 40% by weight, the foam becomes unstable and collapses during the foaming process. As a result, these modest filling levels offer only modest improvement in the thermal properties of the foam.

Traditional urethane foam is created through a process of two separate chemical reactions as is commonly known in the art. The foaming reaction occurs when an isocyanate group reacts with water to create a froth, and one of the products is carbon dioxide gas (CO₂). As the CO₂ is produced, the urethane precursors expand and physically grow in the mold or container they are being formed in. Once the expansion in the mold is largely complete, the gelling reaction takes over with isocyanate groups and —OH group, from a common group of chemicals called polyols. The gelling reaction is what actually makes the polyurethane, and creates a stable flexible foam material. However, during the foaming reaction, the urethane precursors are very unstable, and many things can make the froth collapse. For example, vibrations, speed of the frothing, contaminates, and most importantly, the weight of filling agents, can all make the froth collapse in the mold. In fact, filling agents over 40% of the foam mixture by weight, can often collapse the delicate froth simply due to gravity thereby limiting the amount of filler a urethane foam can hold.

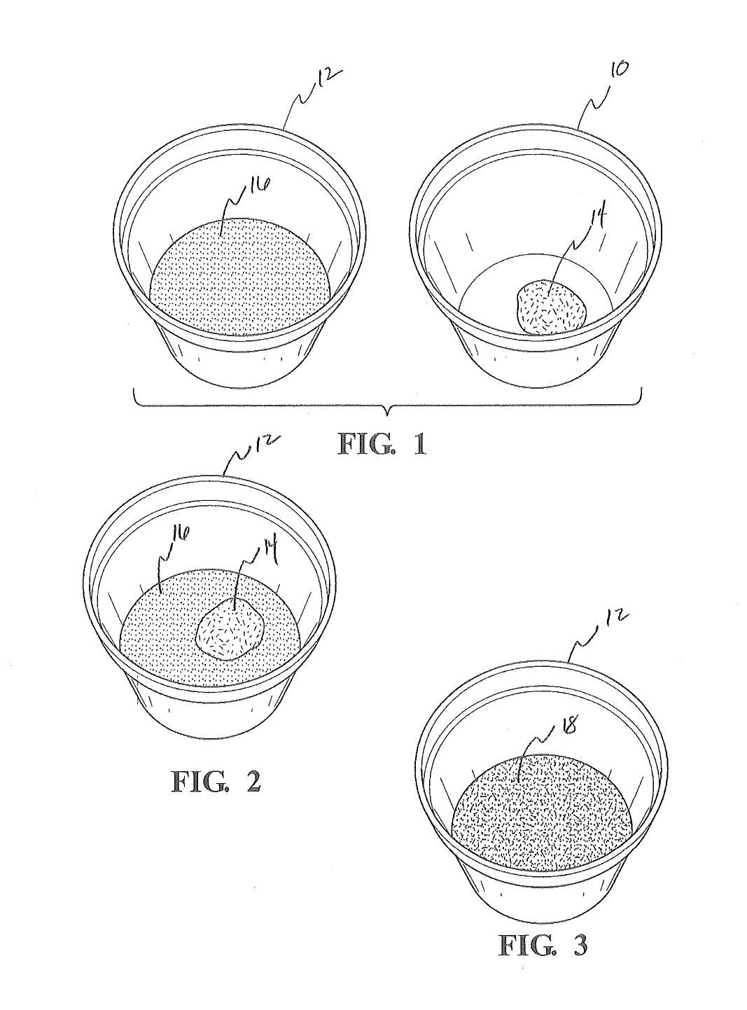

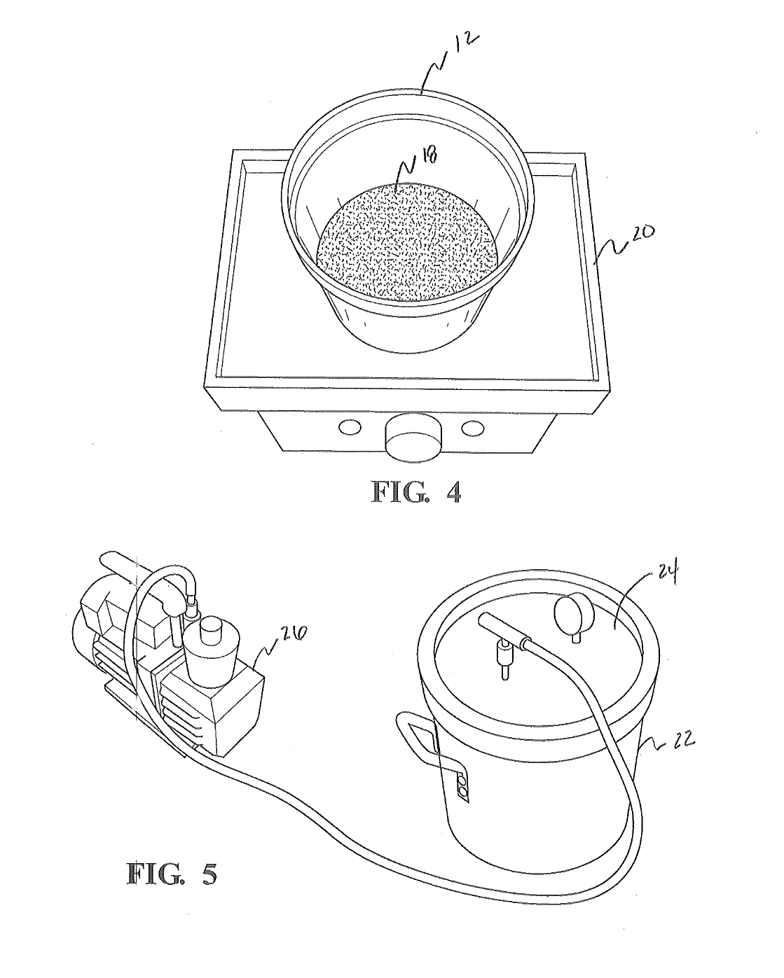

Referring to the Figures, a foam pad and process of manufacturing an ultra high filled urethane foam pad is shown according to one embodiment of the invention. Referring to FIG. 1, a pair of mixing containers are shown at 10 and 12. One of the mixing containers 10 includes a filler material 14, or filling agent, which may consist of aluminum, copper, graphite, graphene, aluminum oxide, silver or other conductive fibers. The other one of the mixing containers 12 includes elastomeric urethane as the preferred resin 16 which is normally free of water such that there is no foaming reaction and only a gelling reaction to create a solid elastomeric urethane. More specifically, the resin is a mixture of an isocyanate component with a resin/polyol component. Referring to FIGS. 2 and 3, the process includes the step of adding the filling agent 14 from container 10 to the resin 16 in container 12 and then thoroughly mixing the filling agent 14 with the resin 16. The combination of filing agent 14 and resin 16 creates an ultra high filled urethane mixture 18. It should be appreciated that the container 12 may be a foam mold of any desired shape and size without departing from the scope of the invention. The next step in the process includes placing the container 12 of the ultra high filled urethane mixture 18 comprised of the filling agent 14 and resin 16 onto a vibration table 20 as shown in FIG. 4 and vibrating the container 12 to remove or reduce any large entrapped bubbles in the mixture 18.

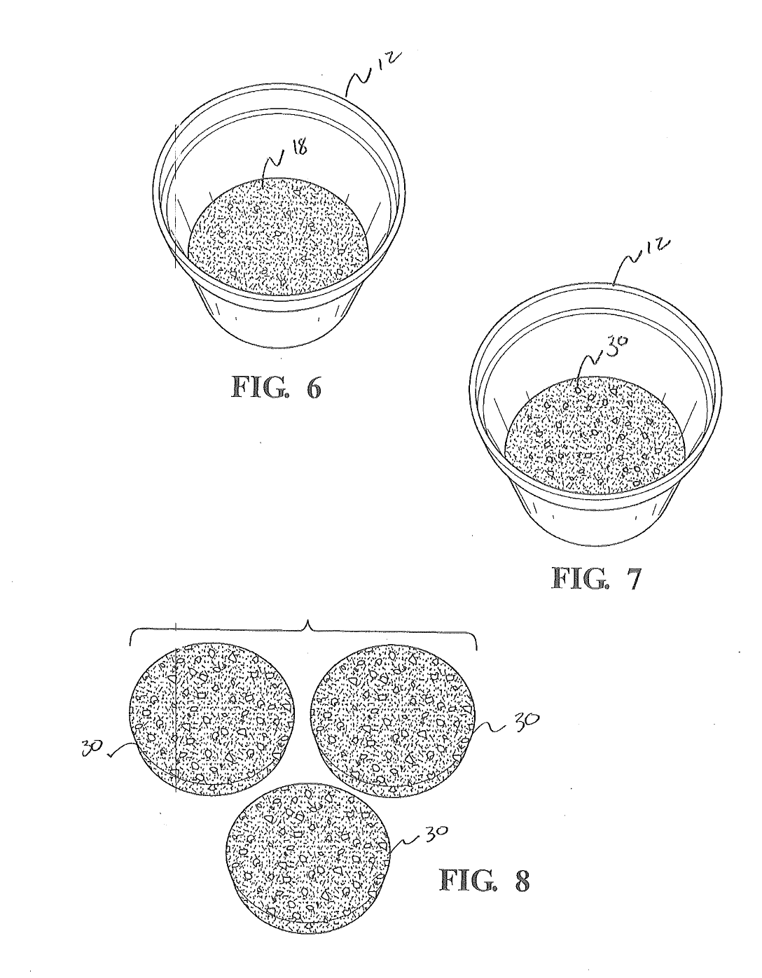

Referring to FIG. 5, the process further includes placing the container 12 and mixture 18 into a vacuum chamber 22 and sealing the chamber 22 with a vacuum seal 24. A vacuum pump 26 is then actuated to draw a vacuum on the chamber 22 at a predetermined and desired vacuum rate and intensity to allow the mixture 18 to froth and foam up in the container 12. The vacuum pump is deactivated and to stop the vacuum draw when the desired foam expansion is achieved allowing the gelling reaction to be completed over a predetermined and desired amount of time. The final step in the process includes releasing the vacuum, opening the vacuum seal 24 and chamber 22, and removing the container 12 with the foamed mixture 18 from the container 12. FIG. 6 shows the mixture 18 prior to the vacuum draw and foam expansion and FIG. 7 shows the foam plus pad 30 after the foam expansion.

Referring to FIG. 8, the thermally enhanced foam plus pad 30 may be cut to various shapes and desired thicknesses for use between the base pad and the trim cover of a seat assembly. The thermally enhanced foam plus pad 30 has an increased thermal conductivity of approximately 0.365 watts/mK, resulting in an 8× improvement over the traditional foam plus pad. By foaming in the vacuum environment, a stable foam with filling or loading levels of 75% or more are achievable, thereby forming urethane foams with properties of the filler agents to greatly improve the thermal conductivity of the foam plus pad 30.

The invention has been described in an illustrative manner, and it is to be understood that the terminology which has been used is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A process for manufacturing a urethane foam pad comprising the steps of:
providing a urethane resin and a filler agent;
mixing a predetermined amount of the filler agent with the urethane resin to create a urethane mixture within a mold container;
drawing a vacuum on the urethane mixture;
allowing the urethane mixture to expand and gel for a predetermined amount of time to form an expanded urethane foam pad;
releasing the vacuum on the urethane mixture; and
removing the expanded urethane foam pad from the mold container.

2. The process as set forth in claim 1 further including the step of vibrating the urethane mixture in the container prior to drawing the vacuum on the urethane mixture.

3. The process as set forth in claim 2 further including the step of allowing the urethane mixture to expand prior to releasing the vacuum.

4. The process as set forth in claim 3 further including the step of allowing the gel reaction on the expanded urethane foam pad for a predetermined amount of time after releasing the vacuum on the urethane mixture.

5. The process as set forth in claim 4 therein the filler agent consist of graphite, graphene, aluminum, aluminum oxide, silver, copper, or conductive fiber.
